(19) United States
(12) Patent Application Publication
(10) Pub. No.: US 2020/0065779 A1
(43) Pub. Date: Feb. 27, 2020

(54) METHODS FOR SEMI-INTEGRATION OF WEB-BASED POINT-OF-SALE SYSTEMS

(71) Applicant: FISKA INC., Montreal (CA)

(72) Inventor: Antoine AZAR, Montreal (CA)

(21) Appl. No.: 16/550,990

(22) Filed: Aug. 26, 2019

Related U.S. Application Data
(60) Provisional application No. 62/723,295, filed on Aug. 27, 2018.
(60) Provisional application No. 62/834,238, filed on Apr. 15, 2019.

(51) Int. Cl. G06Q 20/02; G06Q 20/20; G06Q 20/40; G06F 16/954

(52) U.S. Cl. CPC G06Q 20/027; G06F 16/954; G06Q 20/4014; G06Q 20/20

(57) ABSTRACT

An example method in a bridge server comprises: receiving a bridge identification request, the bridge identification request including a merchant identifier associated with a merchant; transmitting bridge identification data responsive to the bridge identification request, the bridge identification data retrieved based on the merchant identifier, the bridge identification data including an indication that no bridge identifier exists in association with the merchant identifier; receiving, from a client device, a bridge installation request; sending a bridge application installation file to the client device, the bridge application installation file including instructions for installing an instance of a bridge application on the client device; receiving a bridge initiation request from the client device, the bridge initiation request including the merchant identifier; assigning a bridge identifier to the instance of the bridge application; and storing the bridge identifier in association with the merchant identifier.

### FIELD

The specification relates generally to point-of-sale systems, and more particularly methods for semi-integration of cloud-based point-of-sale systems and payment terminals.

### BACKGROUND

Applications are moving to be cloud-based, accessible and executable via web browsers and mobile applications. Cloud-based applications executed via web browsers generally do not interface directly with devices connected on a local network. For example, cloud-based point-of-sale (POS) services accessed via a web browser do not interface directly with payment terminals for receiving payment. Performing transactions therefore uses manual operator input to transfer data from the POS service to the payment terminal and back.

### SUMMARY

According to an aspect of the present specification, a method in a bridge server is provided. The method includes: receiving a bridge identification request, the bridge identification request including a merchant identifier associated with a merchant; transmitting bridge identification data responsive to the bridge identification request, the bridge identification data retrieved based on the merchant identifier, the bridge identification data including an indication that no bridge identifier exists in association with the merchant identifier; receiving, from a client device, a bridge installation request; sending a bridge application installation file to the client device, the bridge application installation file including instructions for installing an instance of a bridge application on the client device; receiving a bridge initiation request from the client device, the bridge initiation request including the merchant identifier; assigning a bridge identifier to the instance of the bridge application; and storing the bridge identifier in association with the merchant identifier.

According to another aspect of the present specification, a non-transitory computer-readable medium is provided. The non-transitory computer-readable medium stores a plurality of computer-readable instructions executable by a processor, wherein execution of the instructions configures the processor to: send a bridge identification request to a bridge server, the bridge identification request including a merchant identifier; receive bridge identification data from the bridge server, the bridge identification data including an indication that no bridge identifier exists in association with the merchant identifier; and responsive to the indication that no bridge identifier exists in association with the merchant identifier, provide, to a client device, a prompt to install a bridge application.

According to another aspect of the present specification, a non-transitory computer-readable medium is provided. The non-transitory computer-readable medium stores a plurality of computer-readable instructions executable by a processor, wherein execution of the instructions configures the processor to: retrieve payment parameters associated with a merchant identifier; scan a local network to detect devices connected to the local network; select a payment terminal from the detected devices based on the retrieved payment parameters; and send a transaction to the selected payment terminal via the local network.

### BRIEF DESCRIPTION OF DRAWINGS

Implementations are described with reference to the following figures, in which:

FIG. 1 depicts a schematic of an example system for processing transactions;

FIG. 2A depicts a block diagram of certain internal components of the components of system of FIG. 1;

FIG. 2B depicts a flowchart of an example method of processing transactions in the system of FIG. 1.

FIG. 2C depicts a schematic of a flow of communications during the method of FIG. 2B.

FIGS. 3A and 3B depict a flowchart of an example method of initiating a bridge in the system of FIG. 1.

FIG. 4 depicts a flowchart of an example method of selecting a payment terminal in the system of FIG. 1.

FIG. 5 depicts a schematic of a flow of communications with network devices during the performance of the method of FIG. 4.

### DETAILED DESCRIPTION

Several approaches exist for use of cloud-based POS services with locally connected payment terminals. A non-integrated approach may use manual intervention for an operator to read a payment amount from the point-of-sale (POS) service and input it into the terminal. A full integration approach may use the POS service to process confidential information, including credit card payment data and customer data. The POS therefore is to be certified according to security protocols and regulations in order to securely receive and process the customer data. A semi-integration approach may allow the POS service to send payment amounts to the payment terminal via a bridge application, or other suitable intermediary computing device, which can communicate locally with the payment terminal. The payment terminal processes the payment information and sends the results back to the POS service via the intermediary computing device.

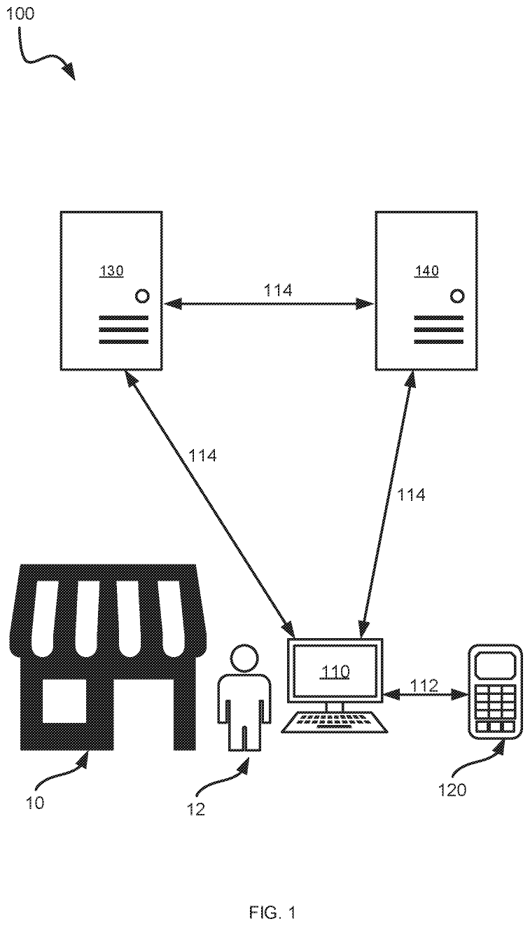

FIG. 1 depicts an example system 100 for processing transactions. The system 100 includes a client device 110 located at a sales location 10, such as a store front, operated by a merchant 12. The client device 110 may be a computing device such as a desktop computer, a laptop computer, a kiosk, or other suitable device. The client device 110 may also be a mobile computing device such as a tablet, smart phone, or the like. The system 100 can include a plurality of client devices 110 at the same sales location 10 (e.g. multiple registers at the same location), or at different sales locations 10 (e.g. multiple store fronts). Specifically, the client device 110 may be configured to allow the merchant 12 at the sales location 10 to sell products or services and to process transactions associated with such sales using a point-of-sale (POS) service.

The client device 110 is therefore in communication with a payment terminal 120 via a communication link 112. The payment terminal 120 can be, for example, an electronic cash register, a card terminal, including a chip and pin terminal, a contactless payment terminal, a magnetic stripe terminal, or other suitable devices for effecting a transfer of funds to complete a sale. In the present example, the payment terminal 120 is a card terminal for electronic fund transfers from a payment card, such as a credit card, a debit card, a gift card, or the like. The communication link 112 can include internet protocol (IP) networks, such as intranet, a local-area network, or a short-range wireless network (e.g., Bluetooth), direct link, such as a universal serial bus (USB) cable or similar, or combinations of the above. In particular, the communication link 112 is a local connection from the client device 110 to the payment terminal 120. Thus, to complete a sale at the sales location 10, the merchant 12 may utilize the client device 110 to register a transaction, transmit the transaction to the payment terminal 120 via the link 112, and use the payment terminal 120 to transfer the funds to complete the transaction.

In some examples, the client device 110 can include a web browser application (e.g. Mozilla Firefox, Google Chrome, and the like) to access a webpage hosted by a POS server 130 which provides web-based POS service. Specifically, the POS server 130 hosts the POS service, accessible via a web browser application of the client device 110, and executable at the client device 110 via the web browser application of the client device 110. However, due to web browser limitations, the POS server 130 cannot configure the POS service to transmit transactions via the web browser application directly to the locally connected payment terminal 120.

Accordingly, the client device 110 further includes a bridge application configured to receive transactions and transmit the transactions to the locally connected payment terminal 120. In particular, the bridge application receives transactions from a bridge server 140, which manages the transfer of communications from the POS server 130 to the bridge application of the client device 110. Specifically, for the merchant 12 accessing the POS service hosted by the POS server 130 via the client device 110, the bridge server 140 provides a bridge for the POS server 130 to push transactions to the instance of the bridge application installed at the client device 110 operated by the merchant 12. The bridge application, in turn, is installed locally on the client device 110, and therefore can communicate with the payment terminal 120 via the link 112.

The client device 110, the POS server 130 and the bridge server 140 are therefore in communication via communication links 114. The communication links 114 may include IP networks, such as intranet, a local-area network, a wide-area network, a virtual private network (VPN), a Wi-Fi network, a short-range wireless network, the internet, combinations of such, and the like. The communication links 114 may be direct links, or links that traverse one or more networks, including both local and wide-area networks.

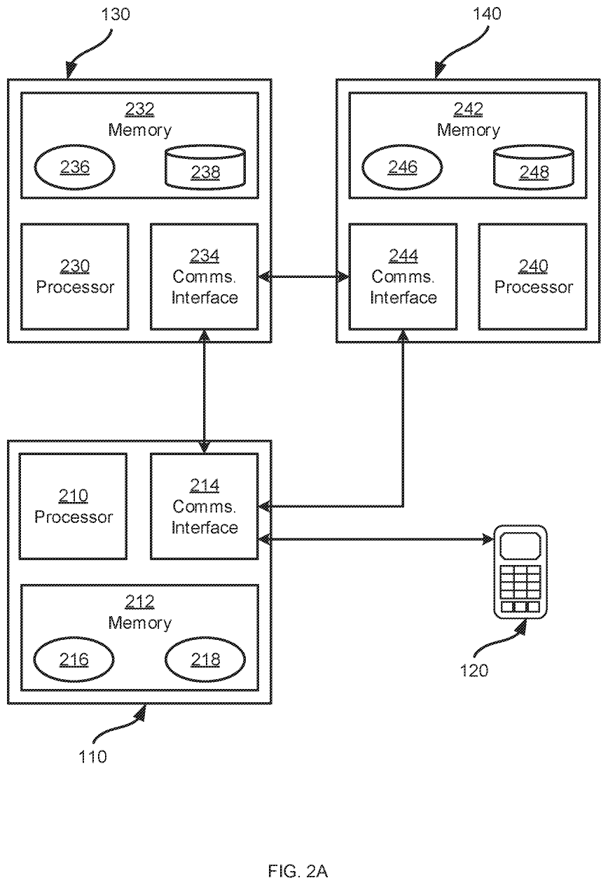

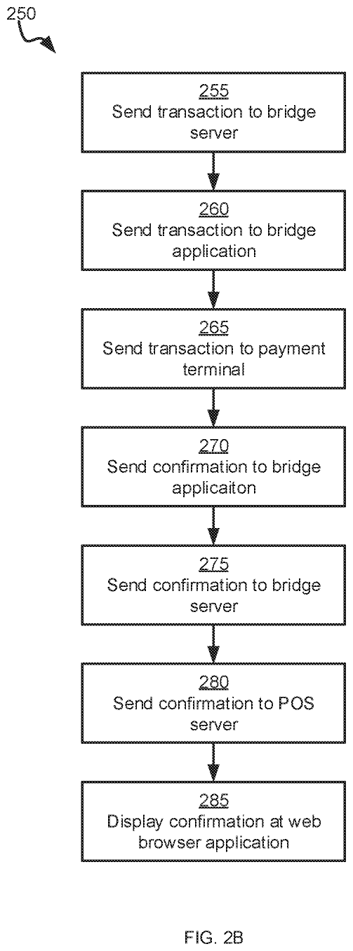

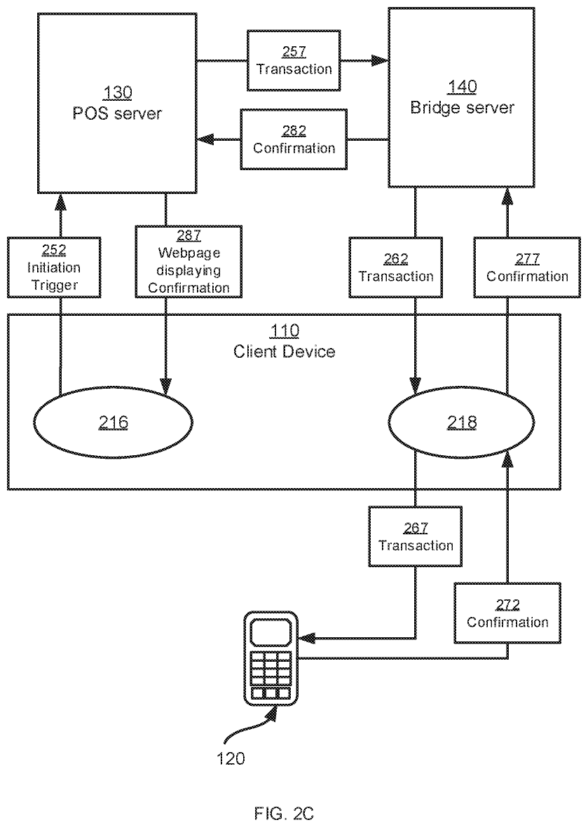

Referring now to FIG. 2A, certain internal components of the client device 110, the POS server 130 and the bridge server 140 are depicted.

The client device 110 includes a processor 210, a non-transitory computer-readable storage medium, such as a memory 212, and a communications interface 214. The processor 210 may include a central-processing unit (CPU), a microcontroller, a microprocessor, a processing core, a field-programmable gate array (FPGA), or similar. The processor 210 may include multiple cooperating processors. The processor 210 may cooperate with the memory 212 to execute instructions to realize the functionality discussed herein. The memory 212 may include a combination of volatile (e.g. Random Access Memory or RAM) and non-volatile memory (e.g. read only memory or ROM, Electrically Erasable Programmable Read Only Memory or EEPROM, flash memory). All or some the memory 212 may be integrated with the processor 210. In particular, the memory 212 stores a plurality of applications, each including a plurality of computer-readable instructions executable by the processor 210. The execution of the instructions by the processor 210 configures the client device 110 to perform various actions discussed herein. The applications stored in the memory 212 include a web browser application 216 (e.g. Mozilla Firefox, Google Chrome, and the like) to access the web-based POS service hosted by the POS server 130, and a bridge application 218 to receive transactions and transmit the transactions to the locally connected payment terminal 120. In some examples, the memory 212 may further include a bridge facilitation application (not shown), provided, for example, in the form of a software development kit (SDK) or the like, to facilitate interactions with the bridge server 140 to identify and/or initiate a bridge.

The client device 110 also includes the communications interface 214 interconnected with the processor 210. The communications interface 214 includes suitable hardware (e.g. transmitters, receivers, network interface controllers and the like) allowing the client device 110 to communicate with other computing devices, such as the payment terminal 120, via the communication link 112, or the POS server 130 and the bridge server 140, via the communication links 114. The specific components of the communications interface 214 are selected based on the type of network or other links that the client device 110 communicates over.

The client device 110 can also include input/output devices, such as a keyboard, mouse, trackpad, touchscreen, monitor, speakers, and the like.

The POS server 130 includes a processor 230, a non-transitory computer-readable storage medium, such as a memory 232, and a communications interface 234. The processor 230 may include a central-processing unit (CPU), a microcontroller, a microprocessor, a processing core, a field-programmable gate array (FPG), or similar. The processor 230 may include multiple cooperating processors. The processor 230 may cooperate with the memory 232 to execute instructions to realize the functionality discussed herein. The memory 232 may include a combination of volatile (e.g. Random Access Memory or RAM) and non-volatile memory (e.g. read only memory or ROM, Electrically Erasable Programmable Read Only Memory or EEPROM, flash memory). All or some the memory 232 may be integrated with the processor 230. In particular, the memory 232 stores a plurality of applications, each including a plurality of computer readable instructions executable by the processor 230. The execution of the instructions by the processor 230 configures the POS server 130 to perform various actions discussed herein. The applications stored in the memory 232 include a POS application (not shown) to provide the web-based POS service. The memory 232 further includes a bridge facilitation application 236 to facilitate interactions with the bridge server 140 and the client device 110 to identify and/or initiate a bridge. In some implementations, the bridge facilitation application 236 may be provided, for example, in the form of a software development kit for integration into the POS application. The memory 232 of the POS server 130 can further include a repository 238, storing merchant identifiers, register identifiers, and other information pertinent to the merchant's use of the POS service hosted by the POS server 130. For example, the repository 238 can include a table defining the type of payment terminal 120 (e.g. as identified by the manufacturer or vendor) used by the merchant 12.

The POS server 130 also includes the communications interface 234 interconnected with the processor 230. The communications interface 234 includes suitable hardware (e.g. transmitters, receivers, network interface controllers and the like) allowing the POS server 130 to communicate with other computing devices, the client device 110 and the bridge server 140, via the communication links 114. The specific components of the communications interface 234 are selected based on the type of network or other links that the POS server 130 communicates over.

The bridge server 140 includes a processor 240, a non-transitory computer-readable storage medium, such as a memory 242, and a communications interface 244. The processor 240 may include a central-processing unit (CPU), a microcontroller, a microprocessor, a processing core, a field-programmable gate array (FPG), or similar. The processor 240 may include multiple cooperating processors. The processor 240 may cooperate with the memory 242 to execute instructions to realize the functionality discussed herein. The memory 242 may include a combination of volatile (e.g. Random Access Memory or RAM) and non-volatile memory (e.g. read only memory or ROM, Electrically Erasable Programmable Read Only Memory or EEPROM, flash memory). All or some the memory 242 may be integrated with the processor 240. In particular, the memory 242 stores a plurality of applications, each including a plurality of computer readable instructions executable by the processor 240. The execution of the instructions by the processor 240 configures the bridge server 140 to perform various actions discussed herein. The applications stored in the memory 242 include a bridge control application 246 configured to manage bridges between merchants and client devices, and in particular, bridge applications 218 installed on the client devices. The memory 242 further includes a repository 248 storing bridge data. For example, the repository 248 can include an association between a merchant identifier associated with a merchant 12 and a bridge identifier associated with an instance of the bridge application 218 installed on a specific client device. Together, the merchant identifier and the bridge identifier define a bridge. The repository 248 can also store other pertinent data for processing transactions via the bridge, such as a POS service provider, a payment terminal provider, payment terminal ports, and the like, as will be described in further detail below.

The bridge server 140 also includes the communications interface 244 interconnected with the processor 240. The communications interface 244 includes suitable hardware (e.g. transmitters, receivers, network interface controllers and the like) allowing the bridge server 140 to communicate with other computing devices, the client device 110 and the POS server 130, via the communication links 114. The specific components of the communications interface 244 are selected based on the type of network or other links that the POS server 130 communicates over.

Referring now to FIG. 2B, an example method 250 of processing transactions is depicted. The method 250 will be described in conjunction with its performance in the system 100, with reference to the components in FIG. 2A. In other examples, the method 250 may be performed in other suitable systems.

The method 250 is initiated at block 255, for example by receiving an initiation trigger at the POS server 130. For example, the POS server 130 may provide a webpage for display by the web browser application 216, the webpage including editable fields, dropdown menus, selectable buttons, and the like, for the merchant 12 to utilize the POS service. Accordingly, the webpage may include a selectable button for the merchant 12 to process a transaction, thereby providing the initiation trigger. At block 255, the transaction is sent from the POS server 130 to the bridge server 140. The transaction can include a transaction amount, a merchant identifier, a register identifier, a terminal identifier and other transaction details. In other examples, the transaction may be sent directly from the client device 110 (e.g. via a suitable application or SDK, or via the POS service running in the web browser application 216) to the bridge server 140.

At block 260, the bridge server 140 retrieves the bridge (e.g. the bridge identifier) based on at least the merchant identifier and sends the transaction to the bridge application 218 on the client device 110. In some examples, the bridge server 140 may actively send the transaction to the bridge application 218 on the client device 110.

In other examples, the bridge server 140 may store the transaction in the repository 248 for further processing. In particular, the transaction may be stored in association with a terminal identifier. The terminal identifier may be pre-stored in association with the merchant identifier and the register identifier, as will be described further herein. Accordingly, the bridge server 140 may select the appropriate terminal identifier based on the merchant identifier and the register identifier received in the transaction. Thus, at block 260, the bridge application 218 on the client device 110 may be configured to retrieve the transaction based on the merchant identifier and the terminal identifier. That is, the bridge application 218 may request transactions associated with the merchant identifier, and, responsive to receiving the request for the transactions, the bridge server 140 may transmit the transaction amount and the terminal identifier to the bridge application. For example, the bridge application 218 may be configured to periodically query the bridge server 140 for transactions for processing. In other examples, the bridge application 218 may request transactions associated with other identifiers, such as the register identifier or the terminal identifier. If the requesting bridge application 218 can communicate with payment terminal associated with the terminal identifier, the transaction is assigned to the requesting bridge application 218. If the requesting bridge application 218 cannot communicate with the payment terminal associated with the terminal identifier, the bridge server 140 may store the transaction as unassigned until the transaction may be assigned to a requesting bridge application 218.

For example, if no bridge identifier exists in association with the merchant identifier received from the POS server 130 at block 255, the bridge server 140 may log the transaction until such time as the bridge is established. Table 1, below, illustrates an example transaction log stored in the repository 248.

TABLE 1
Transaction Loa

| Transaction | Transaction | |
|---|---|---|
| ID | Amount | Status |
| 12345 | $30.45 | Approved |
| 12346 | $19.28 | Declined |
| 12347 | $19.28 | Pending (Sent to bridge application) |
| 12348 | $63.04 | Pending (Setting up bridge application) |
| . . . | . . . | . . . |

As shown above, the transaction log includes a transaction identifier to identify the transaction. The transaction identifier may be uniquely assigned by the bridge server 140 upon receipt of each transaction. In other examples, the transaction identifier may be assigned by the POS server 130, and hence a combination of the transaction identifier, and one or more of a POS server identifier, the merchant identifier, and the bridge identifier (not shown in Table 1) may uniquely identify the transaction in the transaction log. The transaction log further includes a status indicator, indicating the status (e.g. pending, complete, approved, declined) of the transaction. The transaction log may be monitored to ensure that pending transactions are completed. For example, if a transaction remains pending for more than a threshold amount of time, an error report may be sent to an operator of bridge server 140. In some examples, the transaction log can include further details, such as the POS server identifier, the merchant identifier, the bridge identifier, the terminal identifier and the like, to allow the bridge server 140 to determine where to send the transaction and the resulting transaction result.

At block 265, the bridge application 218 transmits the transaction to the payment terminal 120. In some examples, the bridge application 218 may transmit the transaction to the payment terminal 120 based on the terminal identifier associated with the transaction. The terminal identifier may be, for example, the IP address or MAC address of the payment terminal 120. In other examples, prior to transmitting the transaction to the payment terminal 120, the bridge application 218 may be configured to identify the payment terminal 120 from devices on the local network, as will be described further below.

At block 270, the payment terminal processes the transaction and returns a transaction result to the bridge application 218. The transaction result may include, for example, a confirmation of the transaction, including, but not limited to, a confirmation code, and the last four digits of the payment card used to complete the transaction. In other examples, the transaction result can include an indication that the payment was declined.

At block 275, the bridge application 218 forwards the transaction result to the bridge server 140. The bridge server 140 may then update the transaction log with the status of the transaction.

At block 280, the bridge server 140 forwards the transaction result to the POS server 130. In other examples, the bridge server 140 may forward the transaction result directly to the client device 110, for example via a suitable application or SDK at the client device 110.

At block 285, the POS server 130 processes the transaction result and updates the webpage displayed by the web browser application 216 to display the transaction result. For example, the webpage may display a confirmation that the transaction was processed, including the confirmation code and the last four digits of the payment card used, or an indication that the transaction was denied.

Referring to FIG. 2C, the flow of communications during the method 250 is depicted. To initiate the method 250, an initiation trigger 252 is received, for example, from an operator input via the web browser application 216. At block 255, a transaction 257 is sent from the POS server 130 to the bridge server 140. At block 260, a transaction 262 is sent from the bridge server 140 to the bridge application 218. At block 265, a transaction 267 is sent from the bridge application 218 to the payment terminal 120 via the local communication link 112. For example, the transaction 267 may be communicated via a transmission control protocol (TCP). At block 270, a transaction result 272 is sent from the payment terminal 120 to the bridge application 218 via the local communication link 112. At block 275, a transaction result 277 is forwarded from the bridge application 218 to the bridge server 140. At block 280, a transaction result 282 is transmitted from the bridge server 140 to the POS server 130. At block 285, a webpage 287 displaying the transaction result 282 received at the POS server 130 is rendered by the web browser application 216.

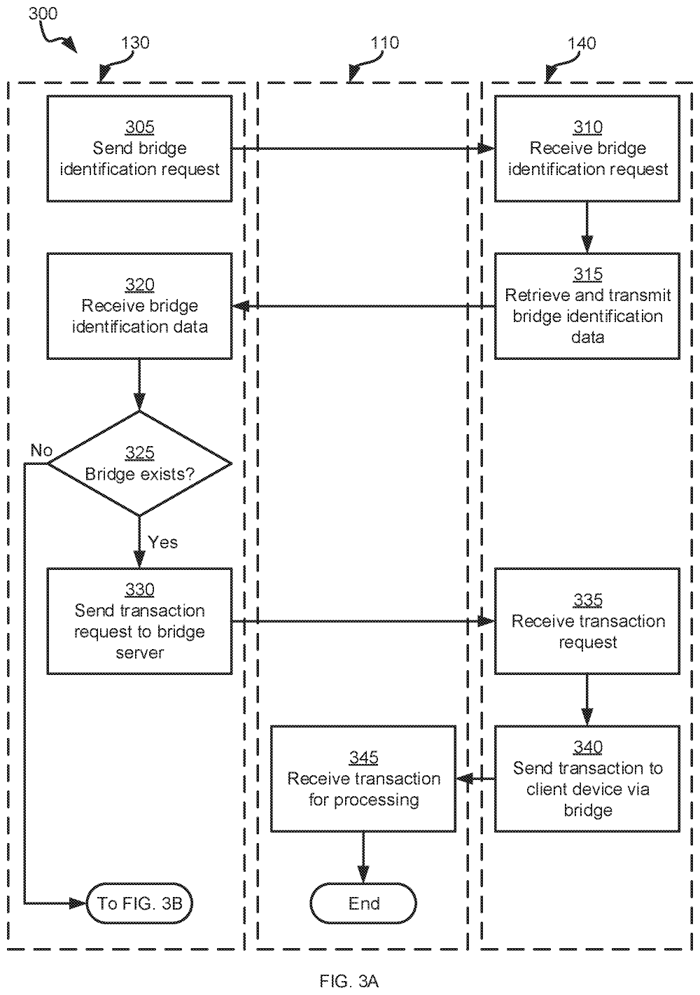

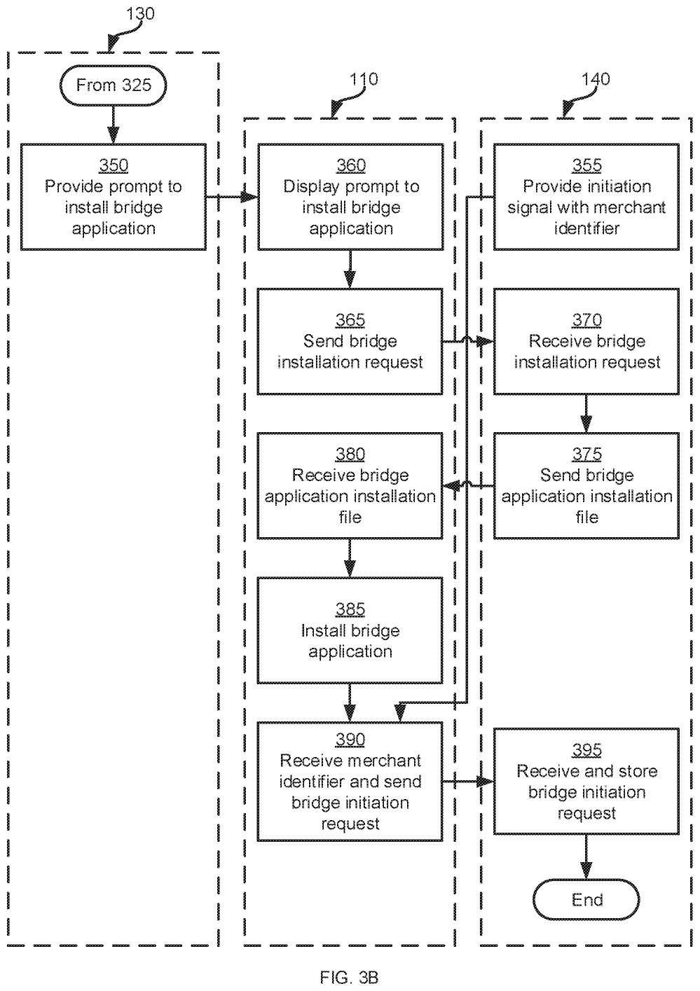

Referring now to FIGS. 3A and 3B, a method 300 of initiating a bridge is depicted. The method 300 will be described in connection with its performance in the system 100, and in particular, by the components described in FIGS. 1 and 2. In other examples, the method 300 may be performed by other suitable systems.

The method 300 is initiated at block 305, for example by receiving an initiation trigger at the POS server 130. For example, the POS server 130 may provide a webpage for display by the web browser application 216, the webpage including a button or a prompt to initiate a bridge. In response to an operator, such as the merchant 12, clicking on the button, the initiation trigger may be sent to the POS server 130. In response to the initiation trigger, the POS server 130 sends a bridge identification request to the bridge server 140. The bridge identification request includes a merchant identifier associated with the merchant 12. The merchant identifier may be stored for example, in the repository 238 at the POS server 130. That is, the method 300 to initiate a bridge may occur prior to the method 250 to process a transaction.

In other examples, the method 300 may be initiated simultaneously with the block 255. For example, the initiation trigger can include a request to process a transaction, and in particular, to process a credit card transaction. Accordingly, the bridge identification request can further include the transaction including transaction details, such as a transaction amount, a transaction identifier, and other pertinent transaction data. For example, the request can include a register identifier associated with the merchant identifier. For example, the merchant 12 may operate multiple registers at the sales location 10, and accordingly, each register may have a separate register identifier.

At block 310, the bridge server 140 receives the bridge identification request. The bridge server 140 may extract parameters from the bridge identification request and store them in the repository 248 for future processing. For example, the bridge server 140 may store the merchant identifier, the transaction amount, other transaction details, and the register identifier in association with the transaction identifier in the transaction log in the repository 248. The bridge server 140 then proceeds to block 315 to process the bridge identification request.

At block 315, the bridge server 140 retrieves bridge identification data based on the bridge identification request. In particular, the bridge server 140 retrieves the bridge identification data from the repository 248 based on the merchant identifier. The bridge identification data can include a bridge identifier associated with the merchant identifier or the bridge identification data may include an indication that no bridge identifier exists in association with the merchant identifier. For example, the first bridge identification request may result in bridge identification data indicating that no bridge identifier exists in association with the merchant identifier. Subsequent bridge identification requests may result in subsequent bridge identification data indicating the bridge identifier associated with the merchant identifier.

Table 2, below, illustrates an example bridge identification record stored in the repository 248.

TABLE 2
Bridge Identification Record

| Merchant | Bridge | POS Service |
|---|---|---|
| ID | ID | Provider |
| M-123 | B-456 | POS Service A |
| M-364 | N/A | POS Service B |
| . . . | . . . | . . . |

As shown above, the bridge identification record includes a merchant identifier uniquely identifying each merchant 12, a bridge identifier uniquely identifying each instance of the bridge application 218 installed on a client device 110, and a POS service provider. Together, the merchant identifier and the bridge identifier define the bridge. The POS service provide allows the bridge server 140 to determine which POS server 130 to communicate with for the given merchant identifier. In some examples, Thus, to retrieve the bridge identification data, the bridge server 140 may retrieve the bridge identifier for the given merchant identifier. The bridge server 140 may also determine that the merchant identifier cannot be found in the bridge identification record. In such examples, the bridge server 140 may store the merchant identifier and the POS service provider until a bridge identifier is received. Further, in some examples the bridge server 140 may determine that the bridge identification record does not include a bridge identifier for the given merchant identifier. In further examples, the bridge identification record may include further details associated with the merchant identifier, such as a register identifier or the like. Specifically, the bridge identification record may include a terminal identifier stored in association with the bridge identifier, the merchant identifier and the register identifier. The terminal identifier may be an IP address, a MAC address, or the like, identifying the selected payment terminal for use with the specific combination of the merchant identifier and the register identifier.

Upon retrieving the bridge identification data, the bridge server 140 is configured to transmit the bridge identification data to the POS server 130.

At block 320, the POS server 130 receives the bridge identification data. The POS server 130 may extract data from the bridge identification data. In particular, the POS server 130 may extract the bridge identifier, or the indication that no bridge identifier exists in connection with the merchant identifier. In some examples, the POS server 130 may store the extracted data for further processing. The POS server 130 then proceeds to block 325 to process the bridge identification data.

At block 325, the POS server 130 determines whether a bridge exists based on the data extracted at block 320. In particular, when the bridge identification data includes a bridge identifier, the POS server 130 determines that a bridge exists. The POS server 130 is then configured to proceed to block 330. When the bridge identification data includes an indication that no bridge identifier exists in association with the merchant identifier, the POS server 130 determines that a bridge does not exist, and proceeds to block 350, as will be described further below.

At block 330, having determined that a bridge exists, the POS server 130 sends a transaction request to the bridge server 140. In some examples, such as when the transaction was previously sent to the bridge server 140 at block 305, the transaction request may simply include a request to process the transaction, and the transaction identifier. In other examples, when the transaction was not sent to the bridge server 140 at block 305, the transaction request can include a transaction amount, the merchant identifier, a register identifier, a terminal identifier and other transaction details.

At block 335, the bridge server 140 receives the transaction request and proceeds to block 340 to process the transaction request.

At block 340, the bridge server 140 identifies the bridge based on the transaction request. For example, the transaction may include the merchant identifier and a transaction amount, and, optionally, a register identifier and a terminal identifier. The bridge server 140 may then be configured to store the transaction in association with the terminal identifier associated with the merchant identifier and the register identifier. The bride server 140 may receive, from the bridge application 218, a request for transactions associated with the merchant identifier, and, responsive to receiving the request for transactions, transmit the transaction amount and the terminal identifier to the client device 110, and in particular, to the bridge application 218. In other examples, upon processing the transaction, the bridge server may actively send the transaction to the bridge application 218 on the client device 110. For example, the bridge server 140 may transmit the terminal identifier to a bridge application 218. If the bridge application 218 can communicate with the payment terminal having the terminal identifier, the bridge server 140 may transmit the transaction amount for processing by the bridge application.

At block 345, the bridge application 218 receives the transaction for processing and completes the transaction. In particular, the bridge application 218 sends the transaction to the payment terminal 120, as will be described further below. Upon receipt of the transaction for processing by the client device 110, the method 300 for initiating the bridge is complete.

If, at block 325, the POS server 130 determines that no bridge exists, the POS server 130 is configured to proceed to block 350 in FIG. 3B.

At block 350, having determined that no bridge exists, the POS server 130 can therefore deduce that the bridge application 218 is not installed at the client device 110. Accordingly, the POS server 130 is configured to provide a prompt to install the bridge application 218. For example, the POS server 130 may provide a prompt to request a bridge application installation file from the bridge server 140. In particular, the POS server 130 can provide an installation request page for requesting the bridge application installation file for display by the web browser application 216 at the client device 110. For example, the installation request page can include a clickable button to request the bridge application installation file from the bridge server 140.

In some examples, the POS server 130 may provide an I-frame within the POS service to provide the prompt to install the bridge application 218. Specifically, the !-frame may display a secondary webpage hosted by the bridge server 140. The bridge server 140 may therefore provide a prompt, such as by including a clickable button, to request the bridge application installation file from the bridge server 140, for display by the secondary webpage within the I-frame.

At block 360, the prompt to install the bridge application 218 is displayed at the client device 110. In particular, the web browser application 216 may render the web page provided by the POS server 130, including the web page provided by the bridge server 140 within the I-frame, to display the prompt to install the bridge application.

Simultaneously with block 360, the bridge server 140 is configured to proceed to block 355. Specifically, upon providing the web page within the I-frame to display the prompt to install the bridge application, the bridge server 140 may also provide, to the web browser application, an initialization signal to be sent via a localhost network to initialize the bridge application 218. For example, a port may be opened the localhost network to listen for hypertext transfer protocol (HTTP) messages. The initialization signal may be a HTTP message sent to the open port on the localhost network, for example, from the POS server 130, or from a bridge initialization application of the client device. The initialization signal includes the merchant identifier and can further include a register identifier (e.g. parameters received in the bridge identification request at block 310). The bridge server 140 continues to provide the initialization signal to the web browser application 216 at the client device 110 until a response to the initialization signal is received at the bridge server. In particular, the response may be a bridge initiation request received from the client device 110, as will be described in conjunction with blocks 390 and 395.

At block 365, the client device 110 sends a bridge installation request to the bridge server 140. In particular, the bridge installation request can include a request for the bridge application installation file.

At block 370, the bridge server 140 receives the bridge installation request and proceeds to block 375 to respond to the bridge installation request.

At block 375, responsive to the bridge installation request, the bridge server sends the bridge application installation file to the client device 110. The bridge application installation file includes instructions that, when executed, install an instance of the bridge application 218 on the client device 110.

At block 380, the client device 110 receives the bridge application installation file. In some examples, a prompt or notification may be displayed at the client device 110 indicating that the bridge application installation file has been received. The notification may provide an option for an operator, such as the merchant 12, initiate execution of the bridge application installation file in order to install an instance of the bridge application 218 on the client device 110. In other examples, the client device 110 may automatically initiate execution of the bridge application installation file upon receipt, without the input of an operator.

At block 385, the client device 110 installs an instance of the bridge application 218 via execution of the bridge application installation file. For convenience, the instance of the bridge application 218 on the client device 110 will also be referred to herein as simply the bridge application 218. In some examples, a notification may be displayed at the client device 110 indicating that the bridge application 218 has been installed. Further, an operator may be provided with a prompt to launch the bridge application 218 (i.e. to execute the bridge application 218 for the first time). In other examples, upon installation of the bridge application 218, the bride application installation file may also contain instructions to automatically launch the bridge application 218.

At block 390, the client device 110 executes the bridge application 218. In particular, upon first launch, the bridge application 218 is configured to listen for an initialization signal on the localhost network of the client device 110 (i.e. the initialization signal provided to the client device 110 by the POS server 130 at block 355). In particular, the initialization signal includes the merchant identifier of the merchant 12 operating the client device 110. Upon receipt of the initialization signal, the bridge application 218 may respond to the initialization signal to indicate that the initialization signal was received. For example, the bridge application 218 may be configured to send a bridge initiation request to the bridge server 140. The bridge initiation request includes the merchant identifier extracted from the initialization signal received via the localhost network, and may further include other parameters extracted from the initialization signal, such as the register identifier. In some examples, the bridge application 218 may select a payment terminal for use, as will be described further below, and may send the terminal identifier to the bridge server 140 as part of the initiation request.

At block 395, the bridge server 140 receives the bridge initiation request from the client device 110, and in particular, from the bridge application 218. The bridge server 140 extracts the parameters from the bridge initiation request to form a bridge. Specifically, the bridge server 140 extracts the merchant identifier and, optionally, the register identifier and the terminal identifier, and assigns a bridge identifier to the instance of the bridge application 218. The bridge server 140 stores the bridge identifier in association with the merchant identifier in the repository 248. The bridge server 140 may further store the register identifier and the terminal identifier in association with the merchant identifier. The association of the bridge identifier and the merchant identifier thus defines a bridge from the merchant using the POS service to communicate with the instance of the bridge application 218 on the client device 110 via the bridge server 140. That is, the merchant 12 may now push transactions from the POS server 130 over the bridge to the bridge application 218 on the client device 110, which in turn, can communicate the transactions over the local network to the payment terminal 120. Accordingly, upon storage of the bridge at block 395, the bridge initiation is complete.

Other variations and implementations of the method 300 are also contemplated. For example, as described above, the bridge identification request can include or be sent simultaneously to a transaction. Further, the determination at block 325 may occur at the bridge server 140 rather than the POS server 130. Accordingly, if the bridge server 140 determines that a bridge exists, the bridge server 140 may proceed directly to process the transaction by sending the transaction to the client device 110 via the bridge. If the bridge server 140 determines that no bridge exists, the bridge server may send an indication that no bridge exists to the POS server 130, and the POS server 130 may proceed to block 350 of the method 300. In further implementations, block 360 may be performed by the POS server 130. That is, the POS server may be configured to send, via the localhost network, the initialization signal for the bridge application 218.

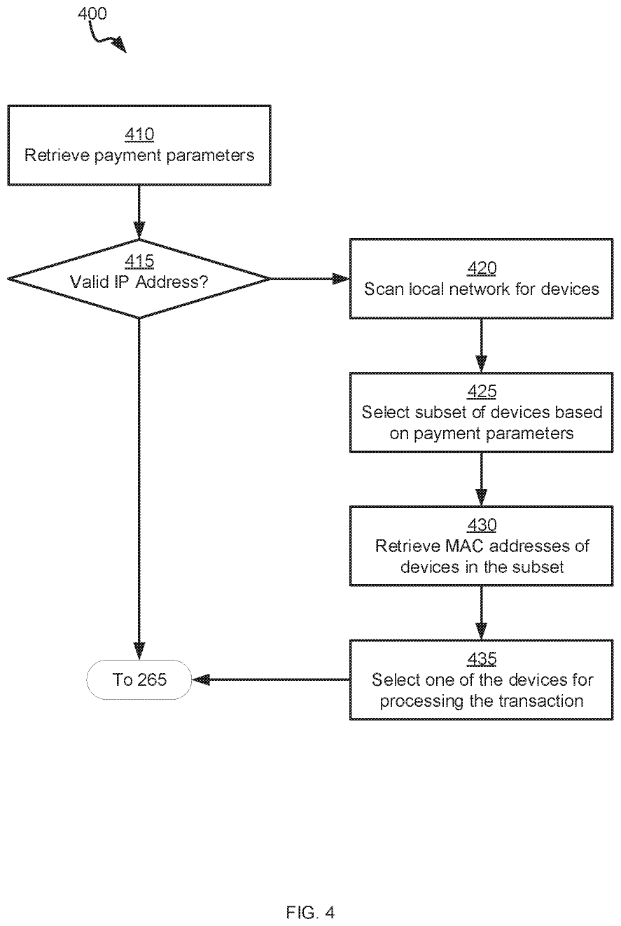

Referring now to FIG. 4, a method 400 of selecting a payment terminal is depicted. The method 400 will be described in conjunction with its performance in the system 100, and in particular by the client device 110 via execution of at least a portion of the bridge application 218. In other examples, the method 400 may be performed in other suitable systems.

The method 400 is initiated at block 410, for example responsive to receiving, at the bridge application 218, a transaction to transmit to a payment terminal. For example, the method 400 may be performed after receipt of the transaction by the bridge application 218 at block 260 of the method 250, and before sending the transaction to the payment terminal at block 265. Specifically, the method 400 may be executed to select a payment terminal to which to send the transaction at block 265. In some examples, the method 400 may be initiated upon initialization of the bridge application 218. For example, the method 400 may be performed after installation of the bridge application 218 at block 385, and after receiving the initialization signal via the localhost network, but before sending the bridge initiation request to the bridge server 140 at block 395.

At block 410, the client device 110 retrieves payment parameters based on the merchant identifier. For example, the client device may send a payment parameter request to the bridge server 140. The payment parameter request includes at least the merchant identifier and can further include the register identifier. The payment parameter request can further include the bridge identifier of the bridge application 218 to allow the bridge server 140 to identify the merchant 12, and hence the payment parameters associated with the merchant 12.

The bridge server 140 receives the payment parameter request and retrieves the payment parameters associated with the merchant 12, for example from the repository 248. Table 3 below illustrates an example payment parameter record stored in the repository 248 of the bridge server 140.

TABLE 3
Payment Parameter Record

| | | | | Current |
|---|---|---|---|---|
| Merchant | Register | POS Service | Payment Terminal | Terminal |
| ID | ID | Provider | Provider | IP |
| M-123 | R-1 | POS Service A | Provider D; Provider E | 1.123.4.56 |
| M-123 | R-2 | POS Service A | Provider D; Provider E | 1.123.4.78 |
| M-364 | R-1 | POS Service B | Provider F | N/A |
| . . . | . . . | . . . | . . . | . . . |

As shown above, the payment parameter record includes a merchant identifier to identify the merchant 12, a register identifier to identify the register being used to process the transaction, a POS service provider to identify the POS server 130 providing the POS service, and a payment terminal provider to identify the providers (e.g. manufacturers and/or vendors of the payment terminals 120, other entity capable of controlling communications capabilities and specifications of the payment terminal). The payment parameter record may be partially populated based on input from a merchant to indicate the POS service provider used by the merchant, and payment terminal provider(s) used by the merchant. In some examples, the bridge server 140 may further store the IP address or MAC address of the payment terminal for each merchant and register combination. In particular, the payment parameter record may store associations between each pairing for multiple payment terminals and multiple registers for a particular merchant.

The IP address may be the most recent IP address of the payment terminal 120 (e.g. if the IP address changes from time to time) or the IP address of the most recently used payment terminal 120 (e.g. if multiple payment terminals are paired to a register and/or merchant). In other examples, this IP address may be determined by the client device 110, and hence is not stored in the payment parameter record. The payment parameter record can also include other payment parameters not shown above.

The bridge server 140 can also obtain further payment parameters based on the payment terminal provider and/or the POS service provider. Table 4, below, illustrates an example payment terminal provider record stored in the repository 248 of the bridge server 140.

TABLE 4
Payment Terminal Provider Record

| Provider | Ports Used | Organizational Unique Identifier |
|---|---|---|
| Provider D | Z | 11223344 |
| Provider E | Y | 22334455 |
| Provider F | X | 33445566 |
| . . . | . . . | . . . |

As shown above, the payment terminal provider record includes a provider identifier to identify the provider, an indication of the port(s) used by the provider to allow communications with their payment terminals, and an organizational unique identifier (OUI). The organizational unique identifier is an identifier included in media access control (MAC) addresses of devices manufactured by the provider to uniquely identify the devices as being manufactured by that provider. In some examples, the payment terminal provider record can include other pertinent details for each provider. In some examples, the repository 248 can also store further payment parameters associated with the POS service provider from a POS service provider record.

Hence, upon receiving the payment parameter request, the bridge server 140 can retrieve, from the payment parameter record, the POS service provider, the payment terminal provider, and, when applicable, the current terminal IP address, based on the merchant identifier and the register identifier. The bridge server 140 can further retrieve, from the payment terminal provider record, the port(s) used and the OUI based on the payment terminal provider. The bridge server 140 can then transmit to the bridge application 218, as the payment parameters, one or more of the current terminal IP address (or MAC address), the port used by the payment terminal provider for communications, the OUI of the payment terminal provider, and any further parameters needed to communicate with the payment terminals assigned to the merchant. For example, the payment parameters may further include communication protocols for use by the bridge application 218 to communicate with the payment terminal (i.e. if payment terminals from different payment terminal providers communicate via different communication protocols). In some examples, the payment parameters may include OUIs and communication ports for multiple payment terminal providers, if, for example, the multiple payment terminal types are supported.

In other examples, the client device 110 may retrieve the payment parameters from a cache stored in association with the bridge application 218, or the like.

At block 415, the client device 110 determines whether it possesses a valid IP address exists. Specifically, when the payment parameters retrieved at block 410 do not include an IP address for a payment terminal, the determination is negative, and the client device 110 proceeds to block 420 to identify a payment terminal. When the retrieved payment parameters include an IP address, the client device 110 may determine whether the IP address is valid and functional. For example, the IP address of the payment terminal 120 may have changed since the most recent transaction, and hence the IP address retrieved at block 410 may be invalid. Accordingly, the client device 110 is configured to proceed to block 420. When the IP address of retrieved at block 410 is valid and functional, the client device 110 proceeds to block 265 of the method 250.

When the determination at block 415 is negative, the client device 110 proceeds to block 420. At block 420, the client device 110 scans the local network to detect devices connected to the network.

At block 425, the client device 110 selects a subset of the detected devices from the scan at block 420 based on the payment parameters retrieved at block 410. In particular, the bridge application 218 selects the devices which are open for communications at the port used by the payment terminal provider for communications. Specifically, devices in which the port is closed will not be payment terminals from the payment terminal provider of the merchant 12. If no devices are open for communications at the port used by the payment terminal provider for communications, the client device 110 may be configured to log or send an error report indicating that no devices were detected.

At block 430, the client device 110 retrieves the MAC addresses of the devices in the subset selected at block 425.

At block 435, the client device 110 selects one of the devices in the subset for processing the transaction. Specifically, the client device 110 selects the device based on the retrieved MAC address and the payment parameters retrieved at block 410. The client device 110 compares the OUI from the payment parameters to the MAC address of the devices in the subset. Specifically, the client device 110 identifies one or more devices in the subset having a MAC address which includes the OUI of the payment terminal provider. Thus, devices having a MAC address including the OUI of the payment terminal provider can be determined to be payment terminals 120 to which the client device 110 may send a transaction for processing. If no devices have a MAC address including the OUI of the payment terminal provider, the client device 110 may be configured to log or send an error report indicating that no devices were detected.

In other examples, different ways of identifying devices as payment terminals are contemplated. For example, after selecting a subset of the detected devices at block 425, the client device 110 may be configured to send a test transaction to each of the devices in the subset via the bridge application 218. The test transaction may be a 1 cent transaction, for example, or a malformed request. The bridge application 218 may then receive responses from each of the devices in the subset and compare each response to an expected response. For example, in response to a malformed request, a well-formatted error message may be returned from payment terminals, while non-payment terminal devices may return a different error message.

Accordingly, the pre-determined expected response may be stored, for example at the bridge server 140 for retrieval by the bridge application 218. The bridge application 218 may compare the response to the test transaction to the expected response to identify payment terminals. The client device 110 may use the test transaction to identify devices as payment terminals instead of or in addition to the identification based on MAC addresses. Thus, if the client device 110 may still be able to identify payment terminals if it is prevented from reading MAC addresses on the network.

In some examples, the client device 110 may identify multiple payment terminals 120 on the network. Accordingly, the client device 110 may present an operator with a selection to select which payment terminal 120 to use. The client device 110 then retrieves the IP address of the selected payment terminal 120. Having acquired the IP address of the selected payment terminal, the client device 110 proceeds to block 265 of the method 250.

More generally, at blocks 425 to 435, the client device 110 is configured to select, from the devices detected at block 420, one device for processing the transaction based on the payment parameters retrieved at block 410.

In some examples, the client device 110 may be configured to store one or more of the acquired IP address and the acquired MAC address of the selected payment terminal, for example, sending a request to the bridge server 140 to store the IP address of the selected payment terminal in association with the merchant identifier in the repository 248. In other examples, the IP address may be stored locally at the client device 110 in a cache associated with the bridge application 218.

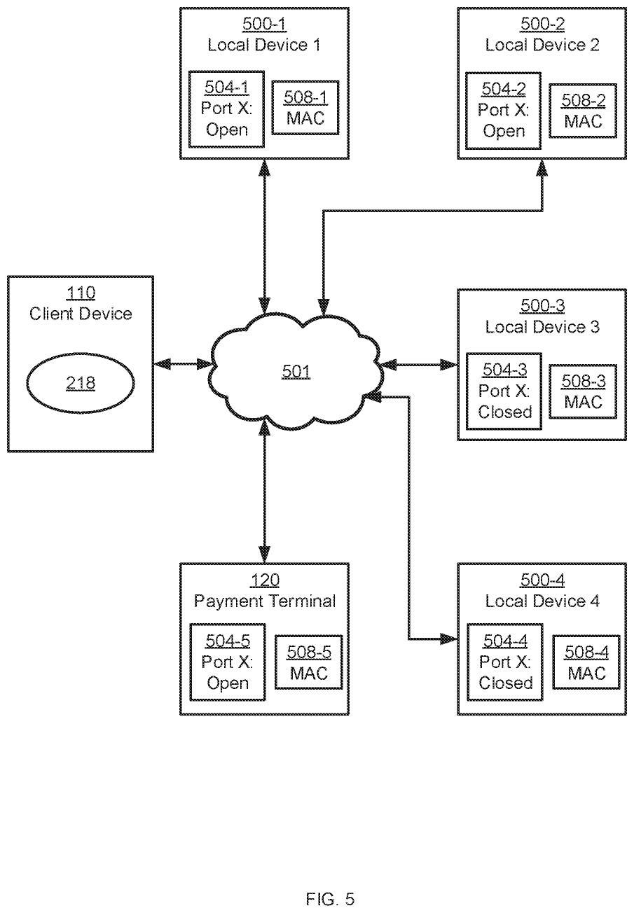

FIG. 5 depicts a schematic of a flow of communications during the method 400. FIG. 5 depicts local devices 500-1, 500-2, 500-3, 500-4, the payment terminal 120, and the client device 110 connected to a local network 501. The local devices 500 have, respectively, ports 504-1, 504-2, 504-3, and 504-4, and MAC addresses 508-1, 508-2, 508-3, and 508-4. The payment terminal 120 also has ports 504-5 and a MAC address 508-5. The local devices 500 may be any computing devices having suitable network interface capabilities to connect to the local network 501. For example, the local devices 500 may be cell phones, printers, routers, and the like.

At block 420, the client device 110 detects the local devices 500 and the payment terminal 120 as being connected to the local network 501.

At block 425, the client device 110 selects a subset of the identified devices based on the ports used. For example, the payment parameters retrieved at block 410 may indicate that the payment terminal provider F uses port X. Accordingly, the client device 110 may determine whether the respective ports 504-1, 504-2, 504-3, 504-4 of the local devices 500 and the ports 504-5 of the payment terminal 120 are open for communication at port X. In the example of FIG. 5, the local devices 500-1, 500-2, and the payment terminal 120 are open for communication at port X, while the local devices 500-3 and 500-4 are closed for communication at port X. Accordingly, at block 425, the client device 110 selects as a subset the local devices 500-1, 500-2 and the payment terminal 120.

At block 430, the client device 110 retrieves the respective MAC addresses 508-1, 508-2, and 508-5 of the local devices 500-1 and 500-2 and the payment terminal 120.

At block 435, the client device 110 compares the MAC addresses 508-1, 508-2, and 508-5 with the payment parameters retrieved at block 410. Specifically, the client device 110 can determine if the MAC addresses 508-1, 508-2, and 508-5 include the OUI retrieved at block 410, thereby indicating that the device is a device provided by the payment terminal provider and having the suitable communication ports open for receiving a transaction. Accordingly, any device which meets such criteria may be determined to be a payment terminal.

In some examples, where the client device 110 detects more than one payment terminal, the client device 110 may be configured to display an option for receiving operator input to select a desired payment terminal. Further, the client device 110 may be configured to provide an option for the operator to send a test transaction to check if the transaction reaches the desired terminal. The client device 110, and in particular the bridge application 218 may receive a request to test a proposed one of the detected devices, and may send a test transaction to the proposed device. The test transaction may be, for example, a 1 cent transaction, or other identifying testing method (e.g. a request to make the terminal beep, change the display, or the like). The client device 110 may subsequently receive a confirmation from the operator, and, responsive to the confirmation, the client device 110 may select the proposed device as the selected payment terminal.

In other examples, the client device 110 may be configured to select a payment terminal, for example based on a pre-selected pairing with a POS register, or a proximity of the payment terminal to the client device 110.

Accordingly, the present disclosure provides systems and methods for semi-integration of web-based POS services with payment terminals. In particular, the system includes a bridge server configured to interface between the POS server and a bridge application installed locally at the client device. The bridge application, in turn, interfaces with the payment terminal, for example via a TCP protocol.

The bridge server, POS server and bridge application are configured to interact in a manner to automatically manage the bridge, including installation of the bridge with minimal operator input. The POS server may be provided with a software development kit, for example in the form a non-transitory computer readable medium having instructions to interact with the bridge server to determine whether a bridge exists. When a bridge exists, the POS server may send a transaction for forwarding to the bridge application. When a bridge does not exist, the instructions of the software development kit prompt download of the bridge application to the client device, for example, by opening an I-frame within the web browser application for displaying content from the bridge server. The bridge server may thus provide an initialization signal for the bridge application via the web browser to be sent via a localhost network. The bridge application, in turn, is configured to listen for the initialization signal, and form the bridge directly with the bridge server based on the initialization signal and configuration settings of the bridge application. Thus, manual operator input is reduced via a direct bridge identification request from the POS server to the bridge server. Thus, in contrast to prior art systems, wherein operators are required to manually enter a bridge application identifier or otherwise manually pair the bridge application to the POS service, the pairing of the merchant's POS service with the bridge application is determined automatically via interaction of the software development kit at the POS server with a bridge identification record at the bridge server, and the bridge application at the client device.

The bridge server and the bridge application are further configured to interact in a manner to automatically pair the bridge application with payment terminals connected on the local network. The bridge server may provide the bridge application with payment parameters pre-stored at the bridge server. The payment parameters allow the bridge application to select one or more possible payment terminals connected to the local network based on ports open for communication, and MAC addresses of the devices connected to the local network. Thus, in contrast to prior art systems, wherein operators are required to manually enter an IP address or a serial number, the bridge application is able to automatically identify payment terminals on the network with little to no operator input, based on the prestored payment parameters associated with the merchant. Further, the pairing between the bridge application and the payment terminal is not affected by changing IP addresses of the payment terminals as the pairing process may be executed at each instance of a transaction, or when the most recent IP address is no longer valid, thus reducing down-time of the system.

The systems and methods of the present disclosure allow for integration into existing infrastructure and facilitates pairing of the POS server to the bridge application, and the bridge application to payment terminals by making the pairings more efficient, and reducing manual operator input, thereby reducing errors in the pairing process.

The scope of the claims should not be limited by the embodiments set forth in the above examples, but should be given the broadest interpretation consistent with the description as a whole.

1. A method in a bridge server, the method comprising:
receiving a bridge identification request, the bridge identification request including a merchant identifier associated with a merchant;
transmitting bridge identification data responsive to the bridge identification request, the bridge identification data retrieved based on the merchant identifier, the bridge identification data including an indication that no bridge identifier exists in association with the merchant identifier;
receiving, from a client device, a bridge installation request;
sending a bridge application installation file to the client device, the bridge application installation file including instructions for installing an instance of a bridge application on the client device;
receiving a bridge initiation request from the client device, the bridge initiation request including the merchant identifier;
assigning a bridge identifier to the instance of the bridge application; and
storing the bridge identifier in association with the merchant identifier.

2. The method of claim 1, wherein the bridge initiation request further includes a terminal identifier of a payment terminal for use with the instance of the bridge application; and
wherein the method further comprises storing the terminal identifier in association with the bridge identifier and the merchant identifier.

3. The method of claim 2, further comprising:
after storing the terminal identifier, receiving a transaction including the merchant identifier and a transaction amount;
storing the transaction in association with the terminal identifier associated with the merchant identifier;
receiving, from the client device, a request for transactions associated with the merchant identifier; and
responsive to receiving the request for transactions, transmitting the transaction amount and the terminal identifier to the client device.

4. The method of claim 2, further comprising:
after storing the terminal identifier, receiving a transaction including the merchant identifier and a transaction amount;
retrieving the terminal identifier associated with the merchant identifier; and
transmitting, based on the terminal identifier, the transaction amount to the client device.

5. The method of claim 3, further comprising:
receiving, from the client device having the instance of the bridge application, a transaction result; and
forwarding the transaction result to a POS server.

6. The method of claim 2, further comprising:
receiving, simultaneously with the bridge identification request, a transaction, the transaction including the merchant identifier and a transaction amount;
storing the transaction in a transaction log for processing; and
after storing the terminal identifier in association with the merchant identifier, transmitting, based on the terminal identifier, the transaction amount to the client device.

7. The method of claim 1, further comprising providing a webpage for display by a web browser application at the client device, the webpage including a prompt to request the bridge application installation file.

8. The method of claim 1, further comprising, providing, to a web browser application at the client device, an initialization signal to be sent via a localhost network to the instance of the bridge application at the client device, the initialization signal including the merchant identifier.

9. A non-transitory computer-readable medium storing a plurality of computer-readable instructions executable by a processor, wherein execution of the instructions configures the processor to:
send a bridge identification request to a bridge server, the bridge identification request including a merchant identifier;
receive bridge identification data from the bridge server, the bridge identification data including an indication that no bridge identifier exists in association with the merchant identifier; and
responsive to the indication that no bridge identifier exists in association with the merchant identifier, provide, to a client device, a prompt to install a bridge application.

10. The non-transitory computer-readable medium of claim 9, wherein execution of the instructions further configures the processor to send a transaction to the bridge server, the transaction including a transaction amount and the merchant identifier.

11. The non-transitory computer-readable medium of claim 9, wherein execution of the instructions configures the processor to provide the prompt to install the bridge application by providing a webpage for display at the client device, the webpage including a clickable button to request a bridge application installation file from the bridge server.

12. The non-transitory computer-readable medium of claim 11, wherein providing the webpage for display at the client device comprises:
providing an I-frame within the webpage, the I-frame displaying a secondary webpage hosted by the bridge server; and
wherein the clickable button to request the bridge application installation file is displayed by the secondary webpage within the I-frame.

13. A non-transitory computer-readable medium storing a plurality of computer-readable instructions executable by a processor, wherein execution of the instructions configures the processor to:
retrieve payment parameters associated with a merchant identifier;
scan a local network to detect devices connected to the local network;
select a payment terminal from the detected devices based on the retrieved payment parameters; and
send a transaction to the selected payment terminal via the local network.

14. The non-transitory computer-readable medium of claim 13, wherein the payment parameters include a port used by a payment terminal provider for communications and an organizational unique identifier (OUI) of the payment terminal provider.

15. The non-transitory computer-readable medium of claim 14, wherein execution of the instructions configures the processor to select the payment terminal by:
selecting a subset of the detected devices, the devices in the subset being open for communications at the port used by the payment terminal provider for communications;
retrieving media access control (MAC) addresses of the devices in the subset; and
selecting the payment terminal by comparing the retrieved MAC addresses to the OUI of the payment terminal provider.

16. The non-transitory computer-readable medium of claim 15, wherein selecting the payment terminal comprises: when more than one of the retrieved MAC addresses includes the OUI of the payment terminal provider, presenting a selection to an operator to select one of the devices as the payment terminal.

17. The non-transitory computer-readable medium of claim 16, wherein selecting the payment terminal further comprises:
receiving a request to test a proposed one of the devices;
sending a test transaction to the proposed one of the devices; and
responsive to receipt of a confirmation from the operator, selecting the proposed one of the devices as the payment terminal.

18. The non-transitory computer-readable medium of claim 14, wherein execution of the instructions configures the processor to select the payment terminal by:
selecting a subset of the detected devices, the devices in the subset being open for communications at the port used by the payment terminal provider for communications;
sending a test transaction to each of the devices in the subset; and
selecting the payment terminal by comparing a response to the test transaction to an expected response.

19. The non-transitory computer-readable medium of claim 13, wherein execution of the instructions further configures the processor to:
retrieve one or more of: an internet protocol (IP) address and a MAC address of the selected payment terminal; and
store the one or more of the IP address and the MAC address of the selected payment terminal.

20. The non-transitory computer-readable medium of claim 19, wherein execution of the instructions configures the processor to store the one or more of the IP address and the MAC address by sending a request to a server to store the one or more of the IP address and the MAC address of the selected payment terminal in association with the merchant identifier.
